(19) United States
(12) Patent Application Publication
(10) Pub. No.: US 2019/0370856 A1
(43) Pub. Date: Dec. 5, 2019

(54) DETECTION AND ESTIMATION OF FRAUDULENT CONTENT ATTRIBUTION

(71) Applicant: comScore, Inc., Reston, VA (US)

(72) Inventors: Aaron J. CAHN, Madison, WI (US); Jeffery T. KLINE, Madison, WI (US); Paul R. BARFORD, Madison, WI (US)

(21) Appl. No.: 15/995,144

(22) Filed: Jun. 1, 2018

(51) Int. Cl. G06Q 30/02; H04L 29/06; H04L 12/26

(52) U.S. Cl. CPC G06Q 30/0248; H04L 43/062; H04L 63/1425; G06Q 30/0277

(57) ABSTRACT

Methods and systems for detection and estimation of fraudulent online advertisement attribution are disclosed. A plurality of network domains and a corresponding plurality of network locations for each network domain are determined based on network traffic data associated with webpage ad placement. The number of the plurality of network locations corresponding to each plurality of network domains is greater than a first threshold value. From the plurality of network locations, a second plurality of network locations is determined in which each network location is associated with two or more network domains of a predefined set of network domains. The number of the two or more network domains exceeds a second threshold value. A report is generated indicating the second plurality of network locations.

### FIELD OF THE INVENTION

This disclosure relates generally to analysis of online activity, and more particularly to detection and estimation of fraudulent online advertisement attribution.

### BACKGROUND

Online advertising is one of the primary revenue sources in the Internet today, measuring in the billions of dollars and growing. These revenues come from the billions of ads (also known as “ad creatives” or simply “creatives”) presented to millions of users every day. The presentation or delivery of an online ads to a user may be referred to as an ad impression. In addition to providing the primary revenue source for the various online content entities (e.g., webpage publishers) or the like, online advertising also allows advertisers to target users having certain attributes or online activity profiles and to evaluate the impact of an online advertising campaign through key metrics, such as click through and conversion.

The process by which an online ad is requested, selected, and delivered for presentation to the user involves a complex distribution system including ad servers, ad exchanges, systems for ad management, monitoring, or fraud detection, and so forth. The process that enables the financial flow from the advertisers to the online content publishers (via any number of intermediary entities) is equally complex. The complexity and scale of this process, as well as the sheer number of entities involved, provide numerous opportunities for fraud. One class of fraud involves causing a misattribution of an ad impression by a fraudulent publisher.

Accordingly, there is a need for improved methods and systems for detecting and/or estimating fraudulent online ad attribution.

### SUMMARY OF THE DISCLOSURE

In one aspect, a method initially receives network traffic indicating network transactions, associated with webpage ad placement, of a panel of client computers. Based on the network traffic data, a plurality of network domains and, for each network domain of the plurality of network domains, a corresponding plurality of network locations are determined. The plurality of network locations corresponding to each network domain of the plurality of network domains comprises a number of network locations that exceeds a first threshold value. The first threshold value may indicate the network domains that are characterizes as low reputation network domains. A second plurality of network locations is determined from the pluralities of network locations. Each network location of the second plurality of network locations is associated with two or more network domains of a predefined set of network domains. The number of the two or more network domains of the predefined set of network domains associated with each network location of the second plurality of network locations exceeds a second threshold value. The pre-defined set of network domains each may be characterized as high reputation network domains. Finally, a report is generated indicating the second plurality of network locations.

In some aspects, the report may further indicate, for each network location of the second plurality of network locations, the two or more network domains of the predefined set of network domains that are associated with the respective network location of the second plurality of network locations. A network location of the second plurality of network locations and a network domain of the corresponding two or more network domains of the predefined set of network domains may be associated with suspected fraudulent webpage ad placement.

In some aspects, a network location of the second plurality of network locations and a second network domain of the corresponding two or more network domains of the predefined set of network domains may be associated with a second suspected fraudulent webpage ad placement.

In some aspects, the method may further comprise determining one or more characteristics associated with a network transaction. The network transaction may be associated with a network location of the second plurality of network locations and a network domain of the associated two or more network domains of the predefined set of network domains. The one or more characteristics associated with the network transaction may comprise at least at least one of a transaction identifier, a URL pattern, a date and time of the network transaction, a client device process that originated the network transaction, a characteristic of a client device associated with the network transaction, a characteristic of a web browser, data associated with an ad placement, data regarding a browser extension, demographic information, a top level browser page, HTTP header field data, cookie data, invalid traffic data, URL pattern data, and domains that were visited before the network transaction.

In some aspects, the network location of the second plurality of network locations and the network domain of the associated two or more network domains of the predefined set of network domains may be indicated as a network transaction in the network traffic data. The one or more characteristics associated with the network transaction may be based on publisher census data associated with a publisher of a webpage comprising the webpage ad placement. The method may further comprise determining a fraudulent webpage ad placement based on the one or more characteristics, wherein the fraudulent webpage ad placement occurs in association with a network transaction not indicated in the network traffic data.

In some aspects, the determining the fraudulent webpage ad placement may comprise determining one or more common characteristic between the one or more characteristics associated with the fraudulent webpage ad placement and the one or more characteristics associated with the network transaction associated with the network location of the second plurality of network locations and the network domain of the associated two or more network domains of the predefined set of network domains.

In some aspects, a network location comprises at least one of an IP address and one or more IP addresses associated with an Internet Service Provider (ISP).

In some aspects, the first threshold value is associated with low reputation network domains and the second threshold value is associated with high reputation network domains. An indication of a network domain as high reputation or low reputation may be based on at least one of: a number of unique visitors to an associated webpage, an average daily time spend by visitors to the associated webpage, an average number of daily pageviews in the associated webpage, and the number of other webpages that link to the associated webpage.

In some aspects, the first threshold value may be based on historical data indicating numbers of network domains previously indicated as low reputation network domains. The second threshold value may be based on historical data indicating numbers of network domains of predefined sets of network domains previously indicated as high reputation network domains.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

In order that the disclosure may be readily understood, aspects of this disclosure are illustrated by way of examples in the accompanying drawings.

FIG. 1 illustrates an exemplary hardware and network configurations for a content provider, an ad provider, an analysis network, and client devices.

FIG. 2 illustrates an exemplary webpage of a content provider.

FIG. 3 illustrates an example flow diagram.

The same reference numbers are used in the drawings and the following detailed description to refer to the same or similar parts.

### DETAILED DESCRIPTION

System and methods are described to detect or estimate fraudulent online advertisement attribution. The complexity of an ad delivery and placement attribution infrastructure and the large sums of money exchanging hands have given rise to numerous fraudulent threats. For example, crawlers, traffic generators, and bots may seek to inflate impression or click counts on publisher webpages. As another example, browser extensions may perform ad calls without a user's knowledge, such as when ads are shown in pop-under windows or invisible iframes. Further, ad injectors or other types of malware may insert unwanted ads on webpages rendered by users. While the aforementioned types of fraud primarily aim to increase the number of ad impressions, a new type of online advertisement fraud has emerged in which an ad impression on a fraudulent party's webpage is misattributed, at least initially, to a legitimate, reputable webpage.

Fraudulent online advertisement attribution may occur when a fraudulent party (e.g., publisher) intentionally causes a misrepresentation of the characteristics of an ad placement with the goal of drawing high priced ads to low quality placements that would otherwise draw only low priced ads from advertisers or ad exchanges. This misrepresentation of the characteristics of the ad placement to manipulate the attribution of a resultant ad impression—and therefore also inflate the associated payment flowing ultimately from the advertiser—may be referred to as placement laundering. Placement laundering by a malicious publisher (likely also classified as a low reputation publisher) may include sending false information along with or as part of an ad request associated with a low quality placement controlled by the malicious publisher. The false information may deceptively characterize the ad request as being associated with a high quality placement controlled by a high reputation publisher. Thus an ad provider may deliver a high priced ad to be rendered with what is actually the low quality placement of the malicious publisher. The malicious publisher may thereby unjustly reap the greater payouts associated with higher priced ads.

A malicious publisher or other entity may enable placement laundering using one or more techniques. For example, a client device may be infected with malware that edits the client device's “hosts” file to alter the IP address to which a given domain resolves. A domain indicated in an HTTP request for an ad may cause the HTTP request to be sent to the altered (and possibly malicious) IP address in the hosts file that corresponds to the domain. As another example, a web browser may be unknowingly configured with a browser extension that examines and modifies HTTP requests relating to ad delivery. The browser extension may perform HTTP header spoofing, for instance. In an example, webpage code may append several hidden iframes to the page's structure. Each hidden iframe may initiate an auction on yet another ad exchange with a “referrer” query string parameter randomly selected from a predefined list. In another example, an API relating to iframes may be used to include malicious code (e.g., JavaScript code) hosted on a third-party server. The malicious code may repeatedly create and destroy iframes that request ads and have tainted “global” objects. The above are examples only and the various techniques that a fraudster may employ to perform placement laundering are not so limited.

As noted, the complex nature of the current infrastructures for ad delivery and attribution makes it difficult to detect if an ad impression was genuinely implemented by the publisher indicated in the associated ad delivery or attribution process or by a fraudulent publisher. For example, the ad delivery process makes an implicit assumption that the information that is sent from a client device to an ad delivery infrastructure when a webpage is rendered is in fact true. Additionally, the information sent to advertisers may be limited by iframes and the diverse paths that an ad request may follow until the ad is served to the client and presented as an ad impression. For example, in a case in which a webpage contains multiple nested iframes, code running within the innermost iframe that tries to identify the outermost iframe's domain must rely on that information being dutifully passed along by all the intermediate parties. Yet further, there are no intrinsic capabilities in current ad delivery and attribution infrastructures that assure or verify that an ad was delivered for a particular placement. For example, current ad infrastructures do not include direct communication between an advertiser's ad server and a publisher, let alone direct communication between the ad server and the publisher that indicates that the ad was in fact delivered to and rendered by the client device. Rather, the ad server communicates only (at least with respect to the delivered ad) with the client device that renders the placement. Thus there is a communication disconnect with respect to the ad request and the ad delivery.

The disclosed systems and methods for detecting or estimating fraudulent online advertisement attribution, including placement laundering, may leverage an observation that a high reputation publisher typically hosts the publisher's webpage content using a limited number (e.g., one or two) of large content providers. It is noted that a publisher, including a high reputation publisher, may be associated with one or more domains (e.g., high reputation domains). A high reputation publisher may include a national retailer or large news agency, for example. The select content provider(s) may provide the robust infrastructure and extensive custom configurations that are often required by a high reputation publisher and associated webpages. Yet these same requirements make migration to another large content provider expensive and time consuming. A large content provider may also be associated with a limited range of IP addresses and/or Internet Service Providers (ISPs). For example, a large content provider may use only a single ISP and that ISP may maintain only a limited set of IP addresses. Thus, the large content provider(s)—and by extension the ISPs and/or IP addresses—associated with a given high reputation publisher may be reliably identified. In contrast, a low reputation publisher (e.g., a fraudulent publisher) may host their webpage content across multiple, low-cost, cloud-based hosting services. The cloud-based hosting services may use a large and diverse set of ISPs and/or IP addresses to serve the low reputation publisher's webpage content. Thus, identical or near-identical HTTP requests to the cloud-based hosting services over several days may indicate or result in contact with one IP address on one day and a second, unrelated IP address on another day.

The disclosed systems and methods may be based on panel data derived from a panel of client devices and their respective users. The client devices of the panel may execute one or more voluntarily-installed applications (“panel application(s)”) that are configured to monitor and record various aspects of a user's online activity and associated communications transacted by the client device, particularly as relates to ad delivery, attribution, and rendering. The panel of users and their respective client devices may serve as a representative sample of the online community at large. Thus data from the panel (as well as any subsequent determinations derived from that data) often may be extrapolated to the whole online community or at least some greater subset of the online community. Further, the panel data may include data that is not available to at least one or more of the publishers, advertisers, or intermediaries. In some cases, some of the panel data may be derived exclusively from the panel applications executing on the client devices. As such, the panel data may offer a more comprehensive picture of the ad delivery and attribution landscape than would be otherwise possible using only data captured by the publishers, advertisers, and any intermediaries.

As some brief examples, the panel data may comprise network traffic data that is recorded by the panel application(s) and associated with a rendered webpage and/or ads in the webpage. The network traffic data may comprise source and/or destination IP addresses that were associated with ads. The network traffic data may further comprise domains and/or publishers that were indicated in HTTP requests (e.g., requests for ads) and the ISP and/or IP address that the client device was caused to contact based on the indicated domain or the ISP and/or IP address that originated the response to the request. Thus the panel data may indicate a plurality of unique and non-unique domains/publishers with each paired with an ISP and/or IP address of a plurality of unique and non-unique ISPs and/or IP addresses.

In an example process to detect or estimate fraudulent online advertisement attribution, including placement laundering, the monitoring system may identify ISPs and/or IP addresses (i.e., network locations(s)) of content provider servers that respond to HTTP ad requests associated—legitimately or fraudulently—with multiple unrelated high reputation publishers. The monitoring system may identify, based on the panel data, domains (e.g., publisher domains) that are each associated with many ISPs and/or IP addresses. For example, an identified domain may have been indicated in many HTTP ad requests (or other transactions relating to ad placement) and these HTTP ad requests caused contact with many different ISPs and/or IP addresses. As another example, an identified domain may have been indicated in many HTTP ad requests and the responses to the requests may have originated from many different ISPs and/or IP addresses. In either of these examples, the domain may have been indicated in the request legitimately or fraudulently.

The multiple different ISPs and/or IP addresses that are associated with the identified domains may suggest that webpage content of a respective domain or associated publisher is hosted across multiple cloud-based hosting services or the like rather than a large content provider that uses a limited number of ISPs and/or IP addresses or even a single ISP. Relatedly, these multiple different ISPs and/or IP addresses are likely associated with cloud-based hosting services or the like instead of a large content provider.

From ISPs and/or IP addresses that are associated with the above-identified domains, the monitoring system may further determine one or more ISPs and/or IP addresses that are associated with a significant number of high reputation domains (e.g., domains associated with a high reputation publisher). For example, an HTTP ad request that is represented in the panel data and associated with one of these just-determined ISPs and/or IP addresses may be determined or estimated to be involved in placement laundering because a bona fide HTTP ad request associated with a high reputation domain likely would not both 1) be associated with a cloud-based content provider; and 2) be an ISP and/or IP address associated with a high reputation domain. Further, the likely determination that an HTTP ad request—which indicates the high reputation domain—resolves to an ISP and/or IP address associated with a cloud-based content provider (and therefore likely also a low reputation publisher) reasonably supports a conclusion that the low reputation publisher's webpage fraudulently drew a high quality ad using the identification of the high reputation domain in the HTTP request. The monitoring system may generate a report that identifies those ISPs and/or IP addresses of content provider servers that respond to HTTP requests associated with multiple unrelated high reputation publishers. The report may further indicate that network transactions that cause a client device to contact those ISPs and/or IP addresses may be part of a place laundering scheme.

By identifying the HTTP ad requests or other network transactions that are suspected to correspond to placement laundering, the monitoring system may determine other characteristics indicated in the panel data that relate to said HTTP ad requests. For example, the panel data may indicate a client device, aspects of the client device, and the process(es) running on the client device that originated the HTTP request. The panel data may further indicate various information from cookies stored on the client device that are associated with the suspect HTTP ad requests. The monitoring system may use these characteristics that are associated with known or suspected instances of placement laundering to determine other instances of placement laundering. For example, various characteristics of a non-panel client device and characteristics of network transactions relating to online ads rendered on a publisher webpage may flag the webpage and/or publisher as possibly taking part in placement laundering. The flagged webpage and/or publisher may be subject to further scrutiny (automated and/or manual) to determine if the webpage and/or publisher is indeed engaging in placement laundering and possibly determine other characteristics surrounding this instance of placement laundering that may be used to further improve methods for placement laundering detection and estimation.

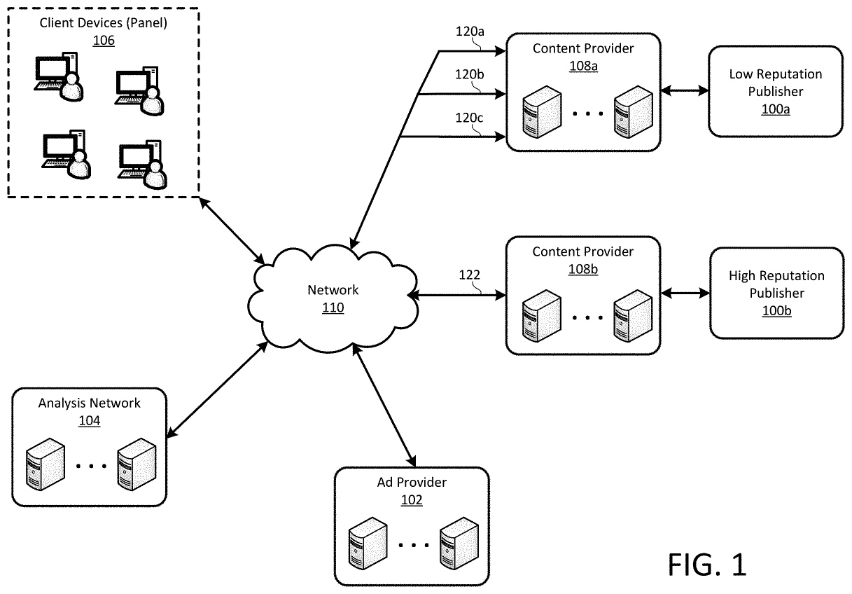

FIG. 1 illustrates exemplary hardware and network configurations for various devices that may be used to perform one or more operations of the described aspects. As shown, content providers 108a,b, an ad provider 102, an analysis network 104, and a panel of client devices 106 are in mutual communication via a network 110. A client device 106 may be configured to render a webpage or other online format (e.g., an “app,” mobile or otherwise) comprising content provided to the client device 106 by a low reputation publisher 100a or a high reputation publisher 100b via the respective content provider 108a,b. Except when useful to distinguish the two, the content providers 108a,b may be generically referred to as the content provider 108. Likewise, the low reputation publisher 100a and the high reputation publisher 100b may be generically referred to as the publisher 100.

The webpage rendered by the client device 106 may comprise one or more ad placements in which an ad is rendered to effectuate a user impression of the ad. The ad may be provided to the client device 106 by the ad provider 102. The ad provider 102 may deliver the ad to the client device 106 responsive to an HTTP request from the client device 106. The HTTP request may indicate a domain associated with a publisher to which the ad impression is intended to be attributed. The analysis network 104 may comprise one or more systems or entities (e.g., intermediaries) that monitor, evaluate, and report various aspects of the ad delivery, ad attributions, and other communications that are performed amongst the client devices 106, the content providers 108, and the ad provider 102.

The client devices 106 may form a voluntary panel of client devices 106. Each of the client devices 106 may be configured with one or more applications (e.g., web browsers) configured to request webpage content and ads, receive said webpage content and ads, and render the content and ads within the application interface. Webpage content and ads may comprise text, video, or images. Webpage content and ads may be provided to the client device 106 in the form of client-side code, such as HTML and JavaScript. The client-side code, when executed by the web browser and/or client device 106, may initiate a request for an ad or webpage content. The client-side code, when executed by the web browser and/or client device 106, may further process a response to the request and cause the requested content or ad to be rendered.

In some instances, an API-compatible web client or other application (including a traditional web browser), executing on the client device 106 may be configured to request for (e.g., via HTTP requests) and be served content, including ads. Ads served in such a manner may “count” as being delivered to the web client or other application for purposes of attribution. Yet such a web client or other application may be hidden from the user and/or started automatically without the user's intervention or even knowledge. An ad served to this web client or other application may not be detectable by code associated with the served ad or other instrumentation available to the advertiser. Thus, a web client or other application so configured may be yet another reason for the difficulties experienced by prior techniques in attempting to detect placement laundering.

Each of the client devices 106 of the panel may be additionally or alternatively configured with one or more voluntarily-installed applications that generate panel data indicating various aspects of the client device 106, the user(s) of the client device, and network traffic received by and sent from the client device 106. The network traffic data indicated in the panel data may be associated with a webpage rendered by the client device 106 and particularly with an ad rendered in the webpage. For example, the network traffic data may include source/destination IP addresses associated with one or more ads, URLs or domains in HTML headers, domains indicated in HTTP requests (e.g., HTTP requests for an ad), and an associated IP address that is contacted by the client device 106 based on the domain indicated in the HTTP request. The panel data may further indicate one or more processes that were executing on the client device 106 and originated an HTTP request for an ad or other network transaction relating to ads.

The panel data may further comprise data relating to the rendering the webpage and/or ad(s) presented with the webpage. For example, the panel data may indicate the time that the webpage and/or ad was rendered, the web browser or other application that rendered the webpage, and any browser plugins, extensions, or other settings associated with the webpage and/or ad. The panel data may further indicate user interaction with a webpage and/or an ad rendered on the webpage. For instance, the panel data may reflect that a user observed a particular ad (e.g., that an impression actually occurred), a user clicked on a particular ad (including information describing that ad), the webpage, domain, and/or IP address to which a user was directed based on an ad click, and the time that a user clicked on an ad. Additionally, the panel data may indicate a top level domain of a rendered webpage.

The panel data may yet further indicate data relating to the user(s) of a client device 106. For example, the panel data may indicate demographic information. The panel data additionally may indicate the online habits of a user, such as the average time spent online over a period of time and the times of day that a user is online. The data relating to a user may be referred to as a user profile.

The panel data may be collected from the client devices 106 of the panel by a monitoring system of the analysis network 104. The monitoring system may aggregate and evaluate the panel data to determine or estimate if any of the panel data indicates or at least suggests that placement laundering or other fraud has occurred.

A client device 106 may be a non-mobile computing device, such as a desktop computer, laptop computer, set-top gaming device, or set-top television device. Additionally or alternatively, a client device 106 may be a mobile device, such as a cellular phone, smart phone, or tablet computer. In an aspect, the client devices 106 are limited to only non-mobile computing devices.

As indicated, the client device 106 may request for and receive webpage content from a publisher 100. More particularly, the client device 106 may request for and receive webpage content from a content provider 108 that stores and delivers webpage content originated by a publisher 100. A publisher 100 may include an entity that controls the webpage content delivered to the client devices 106. As examples, the publisher 100 may be a business, an organization, or even an individual person.

A publisher's 100 webpage content may be delivered to the client devices 106 via a content provider 108. The content provider 108 may offer web hosting services to store or cache the webpage content and deliver the webpage content upon request from a client device 106. Content providers 108 may vary widely in terms of bandwidth capacity, storage capacity, redundancy, services offered, and reliability.

The content provider 108b may be associated with the high reputation publisher 100b. In particular, the content provider 108b may host the webpage content provided by the high reputation publisher 100b. The high reputation publisher 100b may be, for example, a national retailer, a professional sports team, a search engine provider, an online retailer, or a news agency. Due to the large amount of visitor traffic to the high reputation publisher's 100b webpages, as well as a general expectation of a quality web browsing experience, the content provider 108b may include, for example, one or more large-scale data center facilities with multiple web hosting servers that are dedicated to the high reputation publisher 100b and managed by a sophisticated load balancing system. Thus the content provider 108b may afford multiple redundancies for web hosting servers, power, network connectivity, storage, etc., to ensure superior webpage uptime and reliability for the high reputation publisher 100b.

Due to the complexity and scale of the content provider 108b for the high reputation publisher 100b, the content provider 108b may be expected to communicate with the client devices 106 (and other external components) via a limited number (e.g., one or two) of ISPs and therefore also the limited number of IP addresses that are associated with these ISP(s). For similar reasons, it is difficult for the high reputation publisher 100b to migrate to another content provider. Thus, the ISPs and/or IP addresses associated with the high reputation publisher 100b are unlikely to abruptly change. The “limited” number of ISPs and/or IP addresses may be defined according to a threshold quantity value. The threshold quantity value may be associated with content providers that serve a high reputation publisher. Specifically, the number of ISPs and/or IP addresses used by the content provider 108b may be less than the threshold quantity value. The “limited” number of ISPs and/or IP addresses used by the content provider 108b is represented by the single communication line 122 in FIG. 1 that connects the content publisher 108b with the network 110. It is noted that the communication line 122 is illustrative and communication to and from the content provider 108b is not limited to a single communication channel.

The content provider 108a may be associated with the low reputation publisher 100a. In particular, the content provider 108a may host the webpage content and other content provided by the low reputation publisher 100a. The low reputation publisher 100b may be, for example, a malicious party intent on causing placement laundering using webpage content provided to the content provider 108a. The webpage content provided by the low reputation publisher 100a may be designed to appear legitimate by including anticipated web content and standard-sized ad placements. Yet the content may be simply drawn periodically from other web sites, such as news feeds or images or videos. In some aspects, the webpage content of the low reputation publisher 100a may attempt to pass itself off as and mimic a legitimate webpage from a high reputation publisher.

In contrast to the high performance and reliable content provider 108b that delivers the webpage content of the high reputation publisher 100b, the content provider 108a may be realized as a low-cost, cloud-based hosting service. For example, hosting resources provided for the low reputation publisher's 100a webpage content by the content provider 108a may be shared with a number of other publishers and subject to frequent outages. As a cloud-based hosting service in this example, the content provider 108a may not be associated with a consistent and limited set of ISPs and/or IP addresses as may be the case with the content provider 108b. Thus, communications between the content provider 108a and the client devices 106 (and other external components) may be effectuated via a relatively large number of different ISPs and/or IP addresses. The aspect that the content provider 108a communicates via a large number of ISPs and/or IP addresses is represented by the multiple communication lines 120a, 120b, and 120c in FIG. 1. It is noted, however, that the three communication lines 120a, 120b, and 120c are only illustrative and the communication channels to and from the content provider 108a are not so limited. In some aspects, the content provider 108a and/or the content provider 108b may integrate the associated ISP(s).

In an example, the webpage content from the low reputation publisher 100a that is stored with the content provider 108a may be shifted between hosting resources, causing the associated ISPs and/or IP addresses to also change. In some cases, the low reputation publisher 100a may move between different, unrelated cloud-based hosting services or the low reputation publisher 100a may have the webpage content hosted on several, unrelated cloud-based hosting services at the same time. In these and similar cases, the content provider 108a may collectively refer to several different and otherwise unrelated content providers. While this example of the content provider 108a is characterized as one or more cloud-based hosting services, the disclosure is not so limited. Rather, the content provider 108a may be realized as any number and/or types of content providers, hosting service, or the like.

The number of ISPs and/or IP addresses used by the content provider 108a may be larger than the number of ISPs and/or IP addresses used by the content provider 108b, sometimes by several orders of magnitude. The “large” number of ISPs and/or IP addresses used by the content provider 108a may be defined according to a threshold quantity value. This threshold quantity value may be associated with low reputation publishers. Specifically, the number of ISPs and/or IP addresses used by the content provider 108a may be greater than this threshold quantity value. The threshold quantity value associated with the ISPs and/or IP addresses serving the content provider 108a may be larger by several orders of magnitude than the threshold quantity value associated with the ISPs and/or IP addresses serving the content provider 108b.

Regarding the “high reputation” and “low reputation” aspects of the high reputation publisher 100b and low reputation publisher 100a, respectively, these aspects may be each defined according to two respective predefined set of publishers. If the publisher 100b is among the first predefined set, the publisher 100b may be identified as “high reputation.” If the publisher 100a is among the second predefined set, the publisher 100a may be identified as “low reputation.” The “high reputation” and “low reputation” aspects also may be defined according to one or more statistics relating to the high reputation publisher's 100b and low reputation publisher's 100a respective webpage(s). For example, whether a publisher is characterized as “high reputation” or “low reputation” may depend on the number of unique visitors to the webpage, the average daily time spent by a visitor on the webpage, the average daily pageviews in the webpages per visitor, and/or the number of other webpages (not associated with the publisher and/or domain) that link to the webpage. A “high reputation” or “low reputation” characteristic also may be determined according to a global ranking with respect to one or more of the aforementioned webpage statistics. Whether considered according to an absolute statistic or a ranking, “high reputation” and “low reputation” may be determined based on the statistic or ranking in comparison to a threshold statistic or ranking.

The threshold quantity value indicating the number of ISPs and/or IP addresses used by the content provider 108a (and also as characterizing the low reputation publisher 100a and network domain(s) associated with the low reputation publisher 100a and/or content provider 108a) to characterize the content provider 108a as low reputation may be determined based on historical data indicating the numbers of ISPs and/or IP addresses used by content providers that were previously characterized as low reputation. Accordingly, characterizations of associated network domain(s) and the low reputation publisher 100a as low reputation may also be based on the historical data indicating the numbers of ISPs and/or IP addresses used by content providers that were previously characterized as low reputation. Characterizations of the associated network domain(s) and the low reputation publisher 100a may also be based on historical data indicating past characterizations of the associated network domain(s) and low reputation publishers, respectively. A network domain, content provider, and publisher may be characterized as high reputation for similar reasons, except that the number of associated ISPs and IP addresses are less than this threshold value.

As already indicated, the ad provider 102 may deliver the ad to a client device 106. The ad provider 102 may deliver the ad to the client device 106 responsive to an HTTP request from the client device 106. For example, a webpage served to the client device 106 by the content provider 108 may comprise an ad placement. The ad placement may include instructions or code that cause the client device to send the HTTP request for the ad. In some instances, the process of requesting the ad from the ad provider 102 may include several redirects between other systems, such as an ad server associated with the publisher 100 or other systems that affect the determination of what ad is delivered to the client device 106.

The ad provider 102 may be associated with an advertiser (not shown) seeking to market or sell products or services, or an agency or broker acting on behalf of the advertiser. In addition to one or more ad servers that service HTTP requests for ads, the ad provider 102 may include other systems or entities that facilitate the ad delivery and attribution process. For example, the ad provider 102 may include an ad exchange that determines what ad is provided to the client device 106 based on bids from advertisers or their agents. In some aspects, there may be some overlap of functionality between the ad provider 102, analysis network 104, and content provider 108.

The analysis network 104 may comprise one or more systems or entities (e.g., intermediaries) that monitor, evaluate, and report various aspects of the delivery, attribution, rendering, and other steps or communications that are performed amongst the client devices 106, the content providers 108, and the ad provider 102. For example, a system or entity of the analysis network 104 may implement one or more of the disclosed techniques to detect instances or suspected instances of fraudulent online advertisement attribution, including placement laundering.

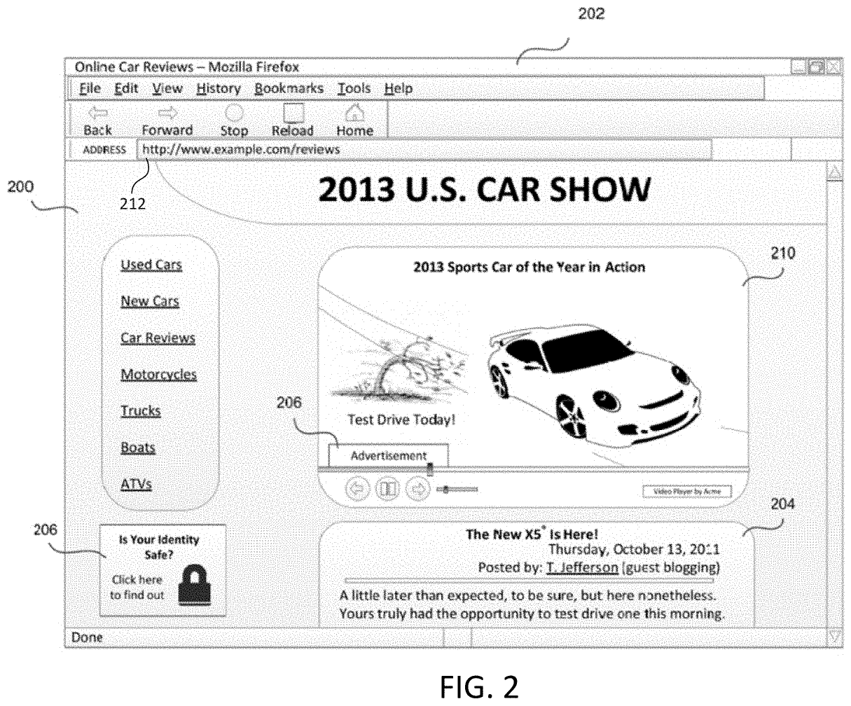

FIG. 2 is a diagram depicting an exemplary webpage 200. The webpage 200 may be that of a publisher 100 and served by a content provider 108. The webpage 200 may be rendered by a web browser 202 on a client device 106 and displayed on a screen of the client device 106. The webpage 200 may include content 204 and at least one ad 206 (i.e., creative). The ad 206 may be a static advertisement, an animated advertisement, a dynamic advertisement, a video advertisement, a public service announcement, or another form of information to be displayed on a screen of the client device 106. The web browser 202 may include a location bar 212 indicating a Universal Resource Locator (URL) (or other type of Uniform Resource Identifier (URI)) for the webpage 200.

In order to render the ad 206, the markup language of the webpage 200 may include an ad tag associated with the desired ad 206. For example, if the webpage 200 is coded with HyperText Markup Language (HTML), the creative tag may be an HTML tag or JavaScript tag that links to the ad 206. The ad tag may direct the client device 106 to retrieve the ad from an ad provider 102. It will be appreciated that the ad tag may be a series of successive links that ultimately redirect to the ad 206. As used herein, the term ad link includes both a direct link to the ad 206 as well as a series of successive links to the ad 206 through, for example, one or more advertisement networks.

Further, the webpage 200 may have instructions for embedding a video player 210 as a part of the content to be displayed on the page. The video player 210 may be configured to play video content, such as video advertisements, to open executable files, such as Shockwave Flash files, or to execute other instructions. The video player 210 may be a separate component that is downloaded and executed by the web browser 202, such as an Adobe Flash, Apple QuickTime, or Microsoft Silverlight object; a component of the web browser 202 itself, such as a HTML 5.0 video player; or any other type of component able to render and play video content within the web browser 202. The video player may be configured to play featured video content in addition to an ad 206. The video player may also be configured to retrieve the ad 206 through an ad tag that links to the desired ad 206.

The content provider 108, the ad provider 102, the analysis network 104, or other system or party may track each time the webpage 200, an ad 206, or other web content is fetched from its source and/or delivered to a client device 106. In addition to simply counting the number of requests for the webpage 200 or the number of impressions of an ad 206, the content provider 108, the ad provider 102, the analysis network 104, or other system or party may track additional related information including an operating system of the client device 106, a web browser, an IP address of the client device 106, a MAC address of the client device 106, a domain of an ad 206, demographic information related to the client device 106, or any other information. The information gathered by the content provider 108, the ad provider 102, the analysis network 104, or other system or party may be used for a variety of purposes including detecting or estimating online advertisement misattribution, including placement laundering.

As already described, the location bar 212 may indicate a URL of the webpage 200. The URL may include a domain name. The particular publisher 100 providing or otherwise associated with the webpage 200 may be determined based on the URL, or portion thereof, indicated in the location bar 212. For example, the publisher 100 may be determined based on the domain name, or portion thereof, indicated in the URL. As shown in FIG. 2, the location bar 212 indicates the URL “http://www.example.com/reviews” in which “www.example.com” and/or “example.com” may be considered domain names. Based on one or more of the domain names indicated in the URL, “example” may be used to determine the publisher 100 of the webpage 200. “Example” (i.e., “example”) may directly reflect the publisher 100 or the publisher may be more indirectly discernable from “example.” For instance, “example” may identify Example, Inc. or Example Van Lines as the publisher 100. The publisher 100 reflected in the URL in the location bar 212 may be the publisher 100 to whom the impression of the ad 206 or other ads on the webpage should be attributed.

It is noted that the URL or other type of URI indicated in the location bar 212 typically may not be accessible to code (e.g., JavaScript code) associated with the webpage 200, the ad 206, and/or the video player 210. Thus advertisers are not able to—nor do they expect to—rely on the URL reflected in the location bar to determine the publisher 100 to whom the impression of the ad should be attributed to. This inability to directly determine the publisher 100 for correct attribution via a URL in the location bar 212 may be yet another factor that has historically enabled placement laundering and presents a challenge, among others, that the disclosed techniques may address.

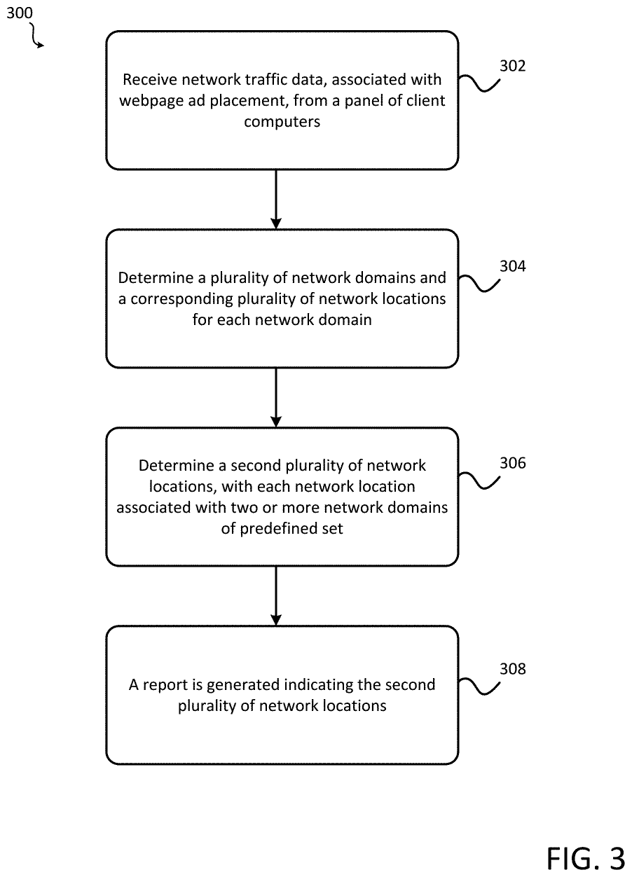

FIG. 3 illustrates an example process 300 for detecting or estimating fraudulent online advertisement attribution, including placement laundering. At step 302, network traffic data may be received. The network traffic data may be received by, for example, a monitoring system of an analysis network (e.g., the analysis network 104 of FIG. 1). The network traffic data (e.g., panel data) may indicate network transactions associated with ad placements in webpages rendered by one or more client devices of a panel of client devices (e.g., the client devices 106 in FIG. 1). The indicated network transactions may have been implemented by a client device to effectuate delivery of an ad for rendering with the ad placement in the webpage. The panel of client devices may be associated with the monitoring system of the analysis network. The client devices may be voluntarily included as part of the panel. The client devices may be each configured with a voluntarily-installed application that monitors, records, and stores data indicating network transactions performed by the client device, particularly those network transactions relating to ad delivery, attributions, and/or rendering. The application may transmit the network transaction data, as well as other information describing the client device and/or users, to the monitoring system.

The network transactions may include a request (e.g., an HTTP request) for the ad associated with the ad placement. The request for the ad may be directed to an ad provider (e.g., the ad provider 102 in FIG. 1). The network traffic data may comprise source and/or destination network locations (e.g., ISPs and/or IP addresses) relating to the request for the ad. For example, the network traffic data may indicate the network location that the request resolved to. As another example, the network traffic data may indicate the network location that is ultimately contacted based on the request for the ad. As yet another example, the network traffic data may indicate a network location that sent a response (e.g., the ad) to the request for the ad. As indicated, a network location may be one or more ISPs, one or more IP addresses, or a combination thereof. An ISP may be identified according to a set of one or more IP addresses. Thus reference to an ISP may additionally or alternatively refer to the IP addresses identified with that ISP. Conversely, reference to one or more IP addresses may additionally or alternatively refer to one or more ISPs, if applicable.

The network traffic data may indicate a domain that was provided in conjunction with the request for the ad. The domain may be indicated as a URL within an HTTP request for the ad, for example. The domain may have been provided with the intent to represent (truthfully or fraudulently) the domain of the webpage. A domain may be associated with a high reputation publisher (the high reputation publisher 100b of FIG. 1) or a low reputation publisher (the low reputation publisher 100a of FIG. 1). The ad that is delivered to the client device may be based on this provided domain, including whether the delivered ad is a high value ad or a low value ad. The domain provided with the ad request may be the true domain of the webpage or it may be fraudulent. A fraudulent domain may be provided with the intent to misrepresent characteristics of the ad placement and/or the webpage so that a higher priced ad is delivered than would be possible if the true domain and/or publisher was provided with the request. For example in a fraudulent ad request, the indicated domain and/or publisher may be characterized as a high reputation domain and/or high reputation publisher.

At step 304, a plurality of network domains is determined and, for each network domain of the plurality of network domains, a corresponding plurality of network locations is also determined. The plurality of network domains and the corresponding pluralities of network locations are determined based on the network traffic data. The plurality of network domains and the corresponding pluralities of network locations may be determined based on network domains indicated in the network traffic data. The network domains of the plurality of network domains may be selected from network domains indicated in the network traffic data. The number (e.g., quantity) of network locations corresponding to each network domain of the plurality of network domains satisfies (e.g., exceeds) a first threshold value. The plurality of network domains and the corresponding pluralities of network locations may be determined by a monitoring system of an analysis network.

A network domain of the plurality of network domains may be associated with a publisher, such as a low reputation publisher or a high reputation publisher. A network domain may be characterized as a high reputation network domain or a low reputation network domain according to whether the associated publisher is a high reputation publisher or a low reputation publisher, respectively. A network domain may be serviced by a content provider. A content provider may be characterized as a high reputation or low reputation according to whether the associated publisher is high reputation or low reputation, respectively.

The first threshold value may be a number of network locations that suggests that a network domain using a number of network locations greater than the first threshold value is or is likely to be a low reputation network domain (e.g., is serviced by a low reputation content provider and/or associated with a low reputation publisher). For example, at least some of these low reputation network domains may use one or more cloud-based hosting services. The number of network locations and the first threshold value may refer to ISPs. Additionally or alternatively, the number of network locations and the first threshold value may refer to IP addresses.

At step 306, a second plurality of network locations is determined from (e.g., selected from) the plurality of network locations determined with respect to step 304. Each network location of the second plurality of network locations is associated with two or more network domains of a predefined set of network domains. The predefined set of network domains may be a predefined set of high reputation domains. The two or more network domains may be different from one another and selected from the network domains indicated in the network traffic data. The number (e.g., quantity) of the two or more network domains of the predefined set of network domains associated with each network location of the second plurality of network locations exceeds a second threshold value.

The threshold value for the number (e.g., quantity) of high reputation network domains in the predefined set of high reputation network domains (as well as threshold value for a number of high reputation content providers and/or publishers in a predefined set, when applicable) may be determined based on historical data. The historical data may indicate the numbers of high reputation network domains in previous predefined sets of high reputation network domains. The determinations that the network domains of the predefined set of network domains are high reputation domains may be based on at least one of a number of unique visitors to an associated webpage, an average daily time spend by visitors to the associated webpage, an average number of daily pageviews in the associated webpage, and the number of other webpages that link to the associated webpage.

In an example, a plurality of network locations determined with respect to step 304 may be suspected of being associated with a low reputation domain, although this is not necessarily known at the time. For example, it may be suspected that this previously-determined plurality of network locations is used by the low reputation domain (and by extension an associated low reputation content provider and/or publisher) due to the number of network locations of the plurality of network locations being greater than the number of network locations typically seen with a high reputation domain (and/or high reputation content provider and/or high reputation publisher). For example, many unrelated ad requests may resolve or cause contact with a single ISP of the plurality of network locations.

Additionally or alternatively, various characteristics of the network transactions captured in the network traffic data may be analyzed. The analyzed network transactions may correspond with the network locations of the second plurality of network locations. The network transactions (and/or other data determined from the network traffic data) corresponding with the network locations of the second plurality of network locations, may be analyzed to determine, for example, one or more common characteristics between at least some of those network transactions. Data analyzed may include an identification of a network transaction, the network domain, and the associated network location. Analyzed data may further include the date/time of the transaction, the processes running on the client device at the time of the transaction, the process on the client device that originated the transaction, characteristics of the client device itself, the web browser, any browser plugins or extensions, demographic information, top-level browser page, data regarding the ad placement, HTTP header field data, cookie data, data relating to invalid traffic, patterns in URL, publisher page views, third party telemetry, ad impressions performed, and a set of domains that a user visited before and/or after the transaction.

The data subject to analysis may include data from the client device, including any types of data discussed with respect to panel data/network traffic data. The data subject to analysis my also include information gathered by a publisher, which may be known as publisher census data. Publisher census data may include information derived from a JavaScript tag or tracking pixel in a webpage, which are activated when the webpage is rendered. Publisher census data also includes HTTP header information, such as timestamp, URL, referrer, and cookie information.

The data subject to analysis may also include data gathered by the advertiser or its agents. Advertiser data may be gathered using an ad tag, which may include JavaScript. Information returned from the ad tag may include a description of the web browser and its settings, as well as the context in which the ad tag code is executed. Some overlap and redundancy is expected between the panel data, publisher census data, and the advertiser data. Although inconsistencies between the three may provide insight into placement laundering schemes. Publisher census data and advertiser data may also be included in the input network traffic data for the process 300.

The common characteristics and other determination resulting from the analysis may form the basis of one or more tools to better detect placement laundering and/or prevent further instances of it. The analysis may also indicate specific instances of suspected placement laundering fraud that guides manual forensic investigation of placement laundering. The data analysis may further be used to estimate the percentage or volume of traffic that may be affected by placement laundering or other types of advertisement misattribution.

At step 308, a report is generated. The report may indicate the second plurality of network locations. The second plurality of network locations may represent those network locations that may be suspected of participating, perhaps unwillingly, in placement laundering. The report may indicate data from the network traffic data associated with the second plurality of network locations, including the transaction identifier and the network domain associated with each transaction indicating a network location of the second plurality of network locations. The report may further include other data from the panel data/network traffic data, publisher census data, and advertiser data. The other data may be indicated with respect to an associated transaction, if applicable. The report may be generated in a format suitable for display on a computer system.

Continuing this example, it may be suspected that the plurality of network locations are used by a cloud-based hosting service. Several (e.g., a number exceeding the second threshold value) unrelated high reputation domains may be identified as being associated with the cloud-based hosting service and/or a network location thereof. For example, the several high reputation domains may map in the network traffic data to one of several ISPs used by the cloud-based hosting service. For example, several ad requests that respectively indicated the different high reputation domains and resolved to or were caused to contact that single ISP of the cloud-based hosting server may be suspect; it is not expected that high reputation domains would use a low reputation cloud-based hosting service. Rather, it is expected that a high reputation domain would use a single ISP, for example, used by a high reputation content provider.

The process 300 of FIG. 3 may be implemented at the content provider 108, the ad provider 102, the analysis network 104, one or more client devices 106, and/or another system or entity. Certain aspects of the content provider 108, the ad provider 102, the analysis network 104, and the client devices 106 of FIG. 1, the webpage 200 of FIG. 2, and the process of FIG. 3 may be implemented as or using a computer program or set of programs. The computer programs may exist in a variety of forms both active and inactive. For example, the computer programs may exist as software program(s) comprised of program instructions in source code, object code, scripts, executable code or other formats, firmware programs(s), or hardware description language (HDL) files. Any of the above may be embodied on a non-transitory computer readable medium, which include storage devices, in compressed or uncompressed form. Exemplary computer readable storage devices may include conventional computer system random access memory (RAM), read-only memory (ROM), erasable, programmable memory (EPROM), electrically erasable, programmable memory (EEPROM), and magnetic or optical disks or tapes.

Certain aspects the ad provider 102, the analysis network 104, the client devices 106, and the content provider 108 of FIG. 1, the webpage 200 of FIG. 2, and the process of FIG. 3 may utilize or include a computer system, which may include one or more processors coupled to random access memory operating under control of or in conjunction with an operating system. The processors may be included in one or more servers, clusters, or other computers or hardware resources, or may be implemented using cloud-based resources. The processors may communicate with persistent memory, which may include a hard drive or disk array, to access or store program instructions or other data. The processors may be programmed or configured to execute computer-implemented instructions to perform the steps disclosed herein.

While the techniques for detecting and estimating online advertisement misattribution, including placement laundering, have been described in terms of what may be considered to be specific aspects, this disclosure need not be limited to the disclosed aspects. Additional modifications and improvements may be apparent to those skilled in the art. As such, this disclosure is intended to cover various modifications and similar arrangements included within the spirit and scope of the claims, the scope of which should be accorded the broadest interpretation so as to encompass all such modifications and similar methods. The present disclosure should be considered as illustrative and not restrictive.

1. A method, comprising:
receiving network traffic data indicating network transactions, associated with webpage ad placement, of a panel of client computers;
determining, based on the network traffic data, a plurality of network domains and, for each network domain of the plurality of network domains, a corresponding plurality of network locations, wherein the plurality of network locations corresponding to each network domain of the plurality of network domains comprises a number of network locations that exceeds a first threshold value;
determining, from the pluralities of network locations, a second plurality of network locations, wherein each network location of the second plurality of network locations is associated with two or more network domains of a predefined set of network domains, wherein the number of the two or more network domains of the predefined set of network domains associated with each network location of the second plurality of network locations exceeds a second threshold value; and
generating a report indicating the second plurality of network locations.

2. The method of claim 1, wherein the report further indicates, for each network location of the second plurality of network locations, the two or more network domains of the predefined set of network domains that are associated with the respective network location of the second plurality of network locations.

3. The method of claim 2, wherein a network location of the second plurality of network locations and a network domain of the corresponding two or more network domains of the predefined set of network domains are associated with a suspected fraudulent webpage ad placement.

4. The method of claim 3, wherein a network location of the second plurality of network locations and a second network domain of the corresponding two or more network domains of the predefined set of network domains are associated with a second suspected fraudulent webpage ad placement.

5. The method of claim 1, wherein the method further comprises:
determining one or more characteristics associated with a network transaction, wherein the network transaction is associated with a network location of the second plurality of network locations and a network domain of the associated two or more network domains of the predefined set of network domains.

6. The method of claim 5, wherein the one or more characteristics associated with the network transaction comprises at least one of: a transaction identifier, a URL pattern, a date and time of the network transaction, a client device process that originated the network transaction, a characteristic of a client device associated with the network transaction, a characteristic of a web browser, data associated with an ad placement, data regarding a browser extension, demographic information, a top level browser page, HTTP header field data, cookie data, invalid traffic data, URL pattern data, and domains that were visited before the network transaction.

7. The method of claim 5, wherein the network location of the second plurality of network locations and the network domain of the associated two or more network domains of the predefined set of network domains are indicated as a network transaction in the network traffic data.

8. The method of claim 5, wherein the one or more characteristics associated with the network transaction are based on publisher census data associated with a publisher of a webpage comprising the webpage ad placement.

9. The method of claim 5, further comprising:
determining a fraudulent webpage ad placement based on the one or more characteristics, wherein the fraudulent webpage ad placement occurs in association with a network transaction not indicated in the network traffic data.

10. The method of claim 9, wherein the determining the fraudulent webpage ad placement comprises determining one or more common characteristic between the one or more characteristics associated with the fraudulent webpage ad placement and the one or more characteristics associated with the network transaction associated with the network location of the second plurality of network locations and the network domain of the associated two or more network domains of the predefined set of network domains.

11. The method of claim 1, wherein a network location comprises at least one of an IP address and one or more IP addresses associated with an Internet Service Provider (ISP).

12. The method of claim 1, wherein the first threshold value is associated with low reputation network domains and the second threshold value is associated with high reputation network domains,
wherein an indication of a network domain as high reputation or low reputation is based on at least one of: a number of unique visitors to an associated webpage, an average daily time spend by visitors to the associated webpage, an average number of daily pageviews in the associated webpage, and the number of other webpages that link to the associated webpage.

13. The method of claim 12, wherein the first threshold value is based on historical data indicating numbers of network domains previously indicated as low reputation network domains.

14. The method of claim 12, wherein the second threshold value is based on historical data indicating numbers of network domains of predefined sets of network domains previously indicated as high reputation network domains.

15. A computer-readable medium storing instruction that, when executed by a processor, effectuate operations comprising:
receiving network traffic data indicating network transactions, associated with webpage ad placement, of a panel of client computers;
determining, based on the network traffic data, a plurality of network domains and, for each network domain of the plurality of network domains, a corresponding plurality of network locations, wherein the plurality of network locations corresponding to each network domain of the plurality of network domains comprises a number of network locations that exceeds a first threshold value;
determining, from the pluralities of network locations, a second plurality of network locations, wherein each network location of the second plurality of network locations is associated with two or more network domains of a predefined set of network domains, wherein the number of the two or more network domains of the predefined set of network domains associated with each network location of the second plurality of network locations exceeds a second threshold value; and
generating a report indicating the second plurality of network locations.

16. The computer-readable medium of claim 15, wherein the report further indicates, for each network location of the second plurality of network locations, the two or more network domains of the predefined set of network domains that are associated with the respective network location of the second plurality of network locations.

17. The computer-readable medium of claim 16, wherein a network location of the second plurality of network locations and a network domain of the corresponding two or more network domains of the predefined set of network domains are associated with suspected fraudulent webpage ad placement.

18. The computer-readable medium of claim 17, wherein a network location of the second plurality of network locations and a second network domain of the corresponding two or more network domains of the predefined set of network domains are associated with a second suspected fraudulent webpage ad placement.

19. A system for fraudulent online advertisement attribution detection and estimate, the system comprising at least one processor connected to at least one storage device, the system being configured to:
receive network traffic data indicating network transactions, associated with webpage ad placement, of a panel of client computers;
determine, based on the network traffic data, a plurality of network domains and, for each network domain of the plurality of network domains, a corresponding plurality of network locations, wherein the plurality of network locations corresponding to each network domain of the plurality of network domains comprises a number of network locations that exceeds a first threshold value;
determine, from the pluralities of network locations, a second plurality of network locations, wherein each network location of the second plurality of network locations is associated with two or more network domains of a predefined set of network domains, wherein the number of the two or more network domains of the predefined set of network domains associated with each network location of the second plurality of network locations exceeds a second threshold value; and
generate a report indicating the second plurality of network locations.

20. The system of claim 19, wherein the report further indicates, for each network location of the second plurality of network locations, the two or more network domains of the predefined set of network domains that are associated with the respective network location of the second plurality of network locations.

21. The system of claim 19, wherein a network location of the second plurality of network locations and a network domain of the corresponding two or more network domains of the predefined set of network domains are associated with suspected fraudulent webpage ad placement.

22. The system of claim 21, wherein a network location of the second plurality of network locations and a second network domain of the corresponding two or more network domains of the predefined set of network domains are associated with a second suspected fraudulent webpage ad placement.
